(19) United States
(12) Patent Application Publication
(10) Pub. No.: US 2009/0286109 A1
(43) Pub. Date: Nov. 19, 2009

(54) Fuel cell system and driving method of fuel cell system

(76) Inventor: Yasushi Araki, Shizuoka-ken (JP)

Correspondence Address: KENYON & KENYON LLP, 1500 K STREET N.W., SUITE 700, WASHINGTON, DC, 20005, US

(21) Appl. No.: 11/990,388

(22) PCT Filed: Aug. 4, 2006
(86) PCT No.: PCT/JP2006/315900

§ 371 Date: Feb. 13, 2008

(51) Int. Cl. H01M 8/04; H01M 8/10

(52) U.S. Cl. 429/13; 429/30; 429/22

(57) ABSTRACT

In a fuel cell system equipped with polymer electrolyte fuel cells, an alternating current generator applies an alternating current of a fixed frequency and a fixed amplitude to the fuel cells. An alternating current voltage acquisition module (combination of a filter unit and an A-D converter with a controller) extracts an alternating current component attributed to the application of the alternating current from an output voltage in a specific unit cell of the fuel cells and time-sequentially obtains a voltage value of the extracted alternating current component. A moisture state monitoring module (the controller) identifies whether the fuel cells have a moistening tendency. In the case of identification of the moistening tendency of the fuel cells by the moisture state monitoring module, an over-hydration detection module (the controller) computes a statistical value representing a magnitude of a variation in time-sequentially obtained voltage value of the alternating current component and determines that the fuel cells are in an over-hydration state when the computed statistical value representing the magnitude of the variation exceeds a preset reference level.

### TECHNICAL FIELD

The present invention relates to a fuel cell system including fuel cells and a driving method of such a fuel cell system.

### BACKGROUND ART

A solid polymer membrane showing the proton conductivity in the wet state is generally applied to electrolyte layers included in polymer electrolyte fuel cells. It is thus essential to keep the solid polymer membrane in the sufficiently wet state for smooth power generation. Water is produced on cathodes of the fuel cells in the course of power generation. Excessive water production or interrupted discharge of produced water may cause flooding and lead to an insufficient supply of a gas to a cathode catalyst. Control is conventionally performed to keep the water content contained in the electrolyte layer, the catalyst, and their periphery at an adequate level. One known method of controlling the water content determines a moisture state of the electrolyte layer based on a variation in output voltage of each unit cell as a constituent unit of the fuel cells. Overhydration of the electrolyte layer is detected in response to a large variation of the output voltage.

### DISCLOSURE OF THE INVENTION

At the timing of detection of the large variation of the output voltage, however, the overhydration state in the solid polymer membrane has already proceeded to an extent of starting a decrease of power generation efficiency. The detected overhydration state is eliminated by regulating the gas flow rate, the amount of humidification, and the gas pressure. Quicker detection of the overhydration state would be required to keep the favorable power generation state of the fuel cells.

There would thus be a demand for enabling quicker detection of an overhydration state inside fuel cells.

In order to accomplish at least part of the above and the other related demands, one aspect of the invention pertains to a fuel cell system equipped with polymer electrolyte fuel cells. The fuel cell system includes: an alternating current component generator configured to apply an alternating current of a fixed frequency and a fixed amplitude to the fuel cells; an alternating current voltage acquisition module configured to extract an alternating current component attributed to the application of the alternating current from an output voltage in a specific unit cell of the fuel cells and to time-sequentially obtain a voltage value of the extracted alternating current component; a moisture state monitoring module configured to identify whether the fuel cells have a moistening tendency; and an overhydration detection module configured to, in the case of identification of the moistening tendency of the fuel cells by the moisture state monitoring module, determine whether the fuel cells are in an overhydration state.

In the fuel cell system according to one aspect of the invention, the overhydration state of the fuel cells is quickly detectable in the case of identification of the moistening tendency of the fuel cells.

The present invention is not restricted to the fuel cell system described above, but may be actualized by diversity of other applications, for example, an overhydration detection method in the fuel cell system and a moving body equipped with the fuel cell system.

### BRIEF DESCRIPTION OF THE DRAWINGS

FIG. 1 is a block diagram schematically illustrating the configuration of a fuel cell system according to one embodiment of the invention;

FIG. 2 is a sectional view schematically showing the structure of a unit cell;

FIG. 3 shows time changes of voltages in fuel cells;

FIG. 4 is a flowchart showing a flooding detection routine;

FIG. 5 shows variations of observed voltage and computed resistance value with a gradual change of the internal state of the fuel cells to a flooding prone state;

FIG. 6 is a flowchart showing one modified flow of the flooding detection routine;

FIG. 7 is a flowchart showing another modified flow of the flooding detection routine; and

FIG. 8 shows a frequency distribution of a preset number of average resistance values.

### BEST MODES OF CARRYING OUT THE INVENTION

Some modes of carrying out the invention are described below with reference to the accompanied drawings.

A. General System Configuration

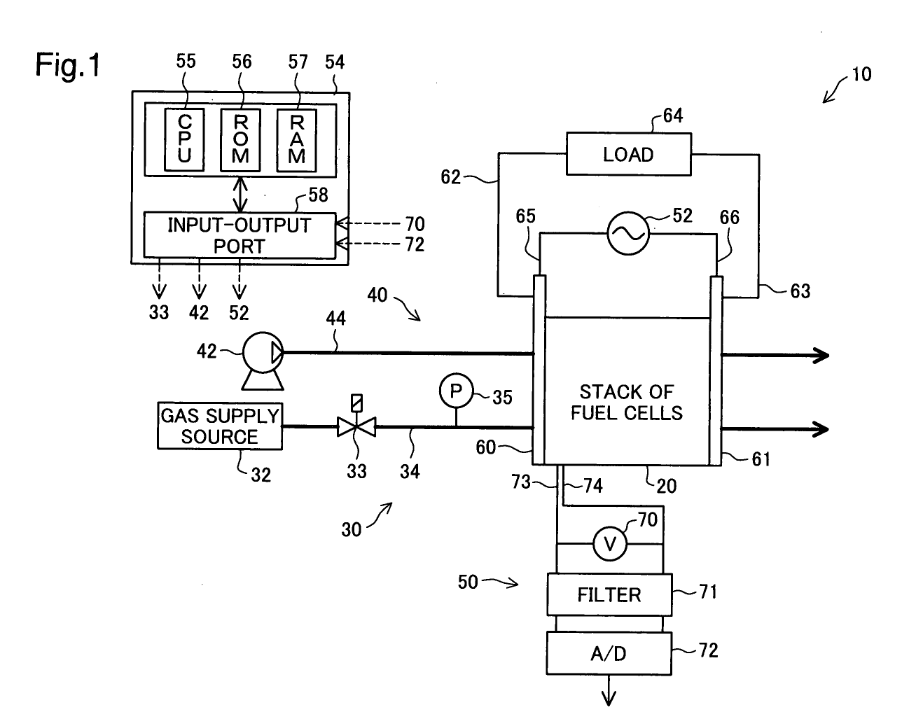

FIG. 1 is a block diagram schematically illustrating the configuration of a fuel cell system 10 according to one embodiment of the invention. The fuel cell system 10 includes fuel cells 20, a fuel gas supplier 30, and an oxidizing gas supplier 40. The fuel cell system 10 also has a voltage detection assembly 50, an alternating current generator 52, and a controller 54 to monitor the moisture state of the fuel cells 20.

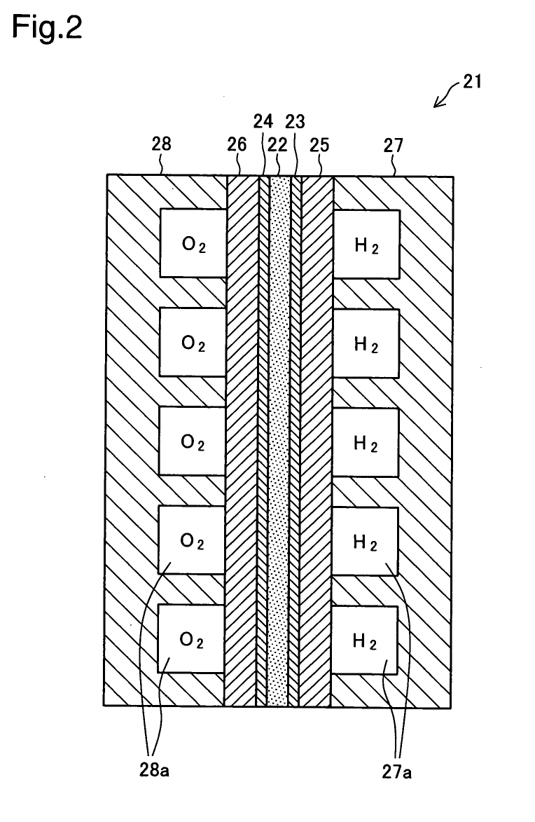

The fuel cells 20 are polymer electrolyte fuel cells. FIG. 2 is a sectional view schematically showing the structure of a unit cell 21 as a constituent unit of the fuel cells 20. The unit cell 21 includes an electrolyte membrane 22, an anode 23, a cathode 24, a pair of gas diffusion layers 25 and 26, and a pair of separators 27 and 28.

The electrolyte membrane 22 is a proton-conductive ion exchange membrane made of a solid polymer material, for example, a fluororesin, and has good electrical conductivity in the wet state. The anode 23 and the cathode 24 are formed on the opposite faces of the electrolyte membrane 22 and respectively contain a metal catalyst (for example, platinum) for accelerating the electrochemical reaction, a proton-conductive electrolyte, and carbon particles having electron conductivity. The gas diffusion layers 25 and 26 are made of a material having gas permeability and electron conductivity, for example, a metal material like foamed metal or meshed metal or a carbon material like carbon cloth or carbon paper. The separators 27 and 28 are made of a gas-impermeable conductive material, for example, a carbon material like gas-impermeable dense carbon obtained by compaction of carbon powder or a metal material like pressed stainless steel.

The separators 27 and 28 have patterned indented surfaces to allow gas passages in the unit cell 21. The separator 27 and the adjacent gas diffusion layer 25 define an inner-unit cell fuel gas flow path 27a for passage of a hydrogen-containing fuel gas. The separator 28 and the adjacent gas diffusion layer 26 define an inner-unit cell oxidizing gas flow path 28a for passage of an oxygen-containing oxidizing gas. Multiple gas manifolds (not shown) for passage of the fuel gas or the oxidizing gas are provided in the periphery of the unit cells 21 in parallel to the laminating direction of the unit cells 21. The fuel gas is introduced through a fuel gas supply manifold among these multiple gas manifolds, is distributed to the respective unit cells 21, flows through the respective inner-unit cell fuel gas flow paths 27a with being subjected to the electrochemical reaction, and is rejoined to be discharged through a fuel gas exhaust manifold. Similarly the oxidizing gas is introduced through an oxidizing gas supply manifold, is distributed to the respective unit cells 21, flows through the respective inner-unit cell oxidizing gas flow paths 28a with being subjected to the electrochemical reaction, and is rejoined to be discharged through an oxidizing gas exhaust manifold.

A number of the unit cells 21 are laminated to form a stack structure of the fuel cells 20. In the stack of fuel cells 20, a cooling medium flow path (not shown) is formed between adjacent unit cells or at intervals of lamination of every preset number of unit cells to regulate the internal temperature of the stack structure. The cooling medium flow path may be provided, for example, between the separator 27 of one unit cell and the separator 28 of the other unit cell in a pair of adjacent unit cells.

The fuel cells 20 also have a pair of power collectors 60 and 61 at both ends of the stack structure. The power collectors 60 and 61 are respectively connected to wirings 62 and 63. Electric power is supplied from the fuel cells 20 to a load 64 via the wirings 62 and 63. The power collectors 60 and 61 are also respectively connected with wirings 65 and 66, which are linked to the alternating current generator 52. The alternating current generator 52 generates an alternating current of a fixed frequency and a fixed amplitude. A weak high-frequency alternating current is applied between the power collectors 60 and 61 of the fuel cells 20 by the alternating current generator 52. The application of the alternating current by the alternating current generator 52 aims to obtain a resistance value (impedance) of the unit cell 21 in the stack of fuel cells 20 as explained later in detail.

In the stack of fuel cells 20, the voltage detection assembly 50 is provided for one specific unit cell selected among the number of unit cells 21. The voltage detection assembly 50 includes a voltage sensor 70, a filter unit 71, and an A-D converter 72. The voltage sensor 70 is connected to the specific unit cell via wirings 73 and 74 to measure a voltage of the specific unit cell. The wirings 73 and 74 are also connected with the filter unit 71 to extract an alternating current component by elimination of a direct current component of the voltage and with the A-D converter 72 to digitalize a signal representing the alternating current component of the voltage extracted by the filter unit 71. The voltage detection assembly 50 is used to measure the voltage of the specific unit cell and monitor the moisture state in this specific unit cell as described later. The specific unit cell specified as the measurement target of the voltage detection assembly 50 is preferably a unit cell prone to flooding in the stack structure, for example, a unit cell located at one end of the stack structure and expected to have a relatively low temperature.

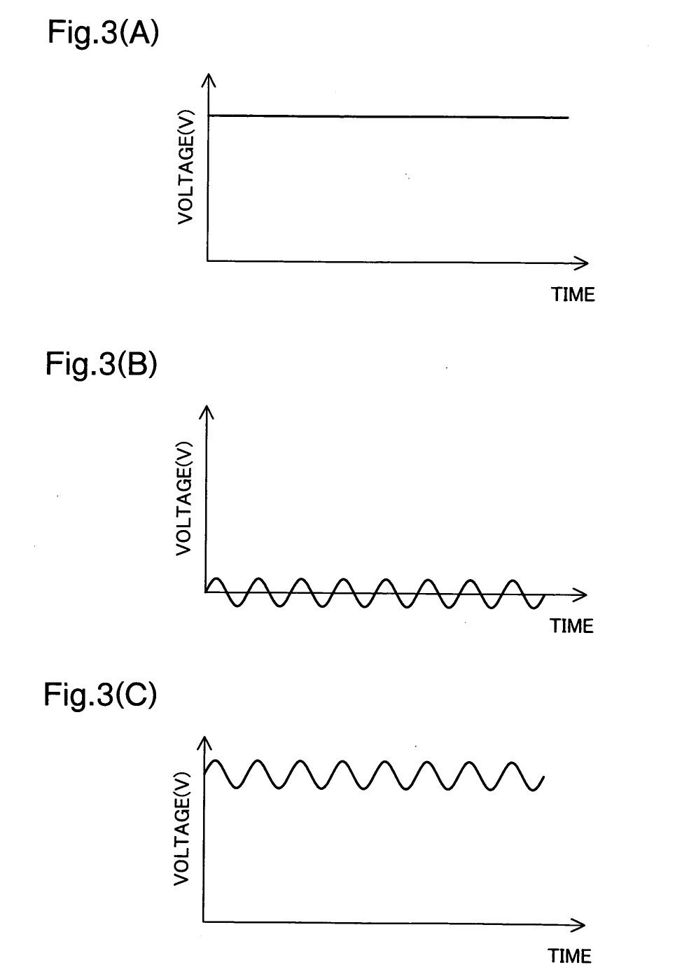

The voltage measured by the voltage sensor 70 is the sum of an output voltage produced by power generation of the fuel cells 20 and a voltage attributed to application of the alternating current by the alternating current generator 52. FIG. 3 shows time changes of voltages in the specific unit cell of the fuel cells 20. FIG. 3(A) shows a time change of a constant output voltage or direct current voltage produced by power generation of the fuel cells 20. FIG. 3(B) shows a time change of an alternating current voltage attributed to application of the alternating current by the alternating current generator 52. FIG. 3(C) shows a time change of the voltage measured by the voltage sensor 70. The voltage sensor 70 detects a superimposed voltage of the direct current voltage of FIG. 3(A) with the alternating current voltage of FIG. 3(B). The output voltage of the fuel cells 20 actually changes with time in response to a variation in load or a variation in temperature of the fuel cells 20. The combined function of the filter unit 71 with the A-D converter 72 eliminates the voltage (direct current component) shown in FIG. 3(A) from the observed voltage of FIG. 3(C) to give the voltage (alternating current component) shown in FIG. 3(B). As described later, the application of the alternating current by the alternating current generator 52 aims to monitor the moisture state in the unit cell based on the alternating current component of the voltage. The amplitude and the frequency of the alternating current to be applied between the power collectors 60 and 61 are adequately set according to the reading accuracy of the alternating current voltage and the magnitude of resistance in the unit cell.

The alternating current generator 52 is not restrictive but may be replaced by an alternating current voltage generator to apply an alternating current voltage, in place of the alternating current, between the power collectors 60 and 61 of the fuel cells 20. In this modified structure, a current sensor is connected to the specific unit cell. The moisture state of the specific unit cell is monitored based on the sum of an electric current generated by power generation of the fuel cells 20 and an electric current attributed to application of the alternating current voltage by the alternating current voltage generator.

The fuel gas supplier 30 has a fuel gas supply source 32 and a fuel gas conduit 34 to supply the hydrogen-containing fuel gas to the respective inner-unit cell fuel gas flow paths 27a formed in the fuel cells 20. In the fuel cell system 10 of the embodiment, the fuel gas is hydrogen gas and the fuel gas supply source 32 is a hydrogen tank. The hydrogen tank may be replaced by a hydrogen container that keeps a hydrogen absorbing alloy therein and stores hydrogen absorbed in the hydrogen absorbing alloy. The fuel gas may alternatively be a reformed gas, and the fuel gas supply source 32 may be a device of producing a hydrogen-rich reformed gas from a hydrocarbon or another suitable fuel. The fuel gas conduit 34 is equipped with a pressure sensor 35 and a pressure regulator 33 to regulate the pressure of the fuel gas supplied from the fuel gas supply source 32.

The oxidizing gas supplier 40 has a blower 42 and an oxidizing gas conduit 44 to supply the air as the oxidizing gas to the respective inner-unit cell oxidizing gas flow paths 28a formed in the fuel cells 20.

The controller 54 is constructed as a microcomputer-based logic circuit and includes a CPU 55 configured to perform various operations according to preset control programs, a ROM 56 configured to store diverse control data and the control programs for execution of the various operations by the CPU 55, a RAM 57 configured to temporarily store diversity of data required for execution of the various operations by the CPU 55, and an input-output port 58 configured to input and output various signals. The controller 54 inputs a measurement signal of the voltage sensor 70 and an output signal of the A-D converter 72, and outputs driving signals to the respective functional units (for example, the alternating current generator 52) involved in monitoring the moisture state in the fuel cells 20 and the respective functional units (for example, the blower 42 and the pressure regulator 33) involved in power generation of the fuel cells 20.

B. Flooding Detection

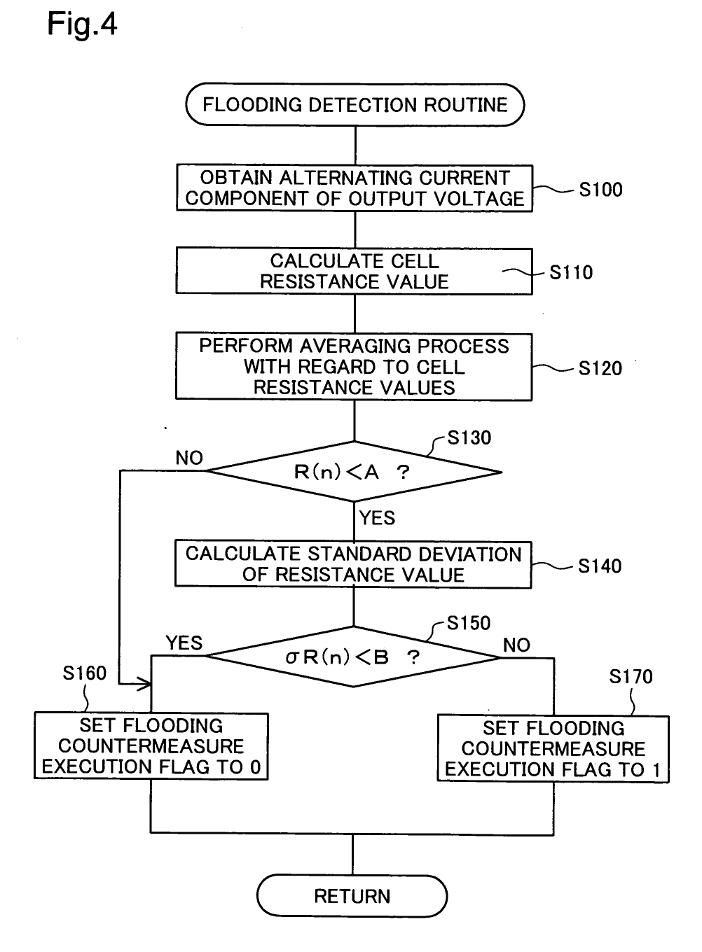

FIG. 4 is a flowchart showing a flooding detection routine executed to monitor the moisture state inside the fuel cells 20 or more specifically to determine whether the internal state of the fuel cells 20 is prone to flooding. This routine is performed at preset time intervals by the CPU 55 of the controller 54, in parallel to general control operations for power generation (for example, control of supply conditions of the fuel gas and the oxidizing gas and temperature regulation of the fuel cells 20) during power generation of the fuel cells 20.

On the start of this flooding detection routine, the CPU 55 first obtains an alternating current component of an observed voltage in a specific unit cell specified as the measurement target of the voltage detection assembly 50 (step S100). The controller 54 works in combination with the filter unit 72 and the A-D converter 72 as the alternating current voltage acquisition module of the invention to time-sequentially obtain the voltage value of the alternating current component. The filter unit 71 and the A-D converter 72 extract the alternating current component attributed to application of the alternating current from the output voltage observed in the specific unit cell of the fuel cells 20. The controller 54 then obtains the voltage value of the extracted alternating current component. The controller 54 receives a signal sequentially sent from the A-D converter 72 and thereby sequentially detects the voltage value of the alternating current component (that is, the amplitude of the alternating current voltage). The controller 54 stores the sequentially detected voltage value into a preset memory and successively updates the voltage value stored in the memory in response to each detection to keep the latest voltage value. At step S100, the CPU 55 obtains the latest voltage value stored in the memory at a specific time interval and uses the obtained voltage value for the subsequent series of processing. The specific time interval should be a sufficiently short timing to capture a voltage change caused by flooding but may be set arbitrarily according to a condition of statistic operation of the obtained voltage value as described later.

The CPU 55 divides the obtained voltage value by the value of electric current applied by the alternating current generator 52 to time-sequentially calculate a resistance value of the unit cell or cell resistance value at the timing of obtaining the voltage value of the alternating current component (step S110). The procedure of this embodiment applies the high-frequency alternating current but extracts only the amplitude of the alternating current voltage for calculation of the resistance value from this amplitude and the value of the applied electric current.

After calculation of the resistance value, the CPU 55 performs an averaging process with regard to the time-sequentially calculated resistance value (step S120). The averaging process computes an average of resistance values calculated from a preset number of voltage values (for example, ‘i’ voltage values) obtained retrospectively from the latest voltage value. At step S120 in an n-th cycle of this routine after activation, the CPU 55 computes an average of resistance values calculated in (n−i+1)-th to n-th cycles. The processing of step S120 successively shifts the range of resistance values as the object of computation of the average value by one to include the latest resistance value in response to every calculation of the resistance value at step S110. In the description hereafter, R(n) denotes the average of the resistance value (average resistance value) computed at step S120 in the n-th cycle of this routine after activation. The averaging process performed at step S120 is intended to eliminate a noise included in the observed voltage value as the base of calculation of the resistance value and suggest the present general tendency of the resistance value. The sampling number ‘i’ of the resistance values used for the averaging process may be set arbitrarily in an allowable range for attaining this purpose.

The CPU 55 then compares the latest average resistance value R(n) computed at step S120 with a preset reference value A (step S130). The reference value A used for the comparison at step S130 is set in advance as a value for identifying the moistening tendency of the specific unit cell and is stored in the controller 54. When the average resistance value R(n) is not smaller than this preset reference value A, it is identified that the specific unit cell has the moistening tendency. Namely at step S130, it is identified whether the specific unit cell as the measurement target of the voltage has the moistening tendency (prone to flooding). The controller 54 accordingly functions as the moisture state monitoring module of the invention for identifying whether the fuel cells have the moistening tendency.

The resistance in the unit cell includes contact resistances between the respective constituents of the unit cell (the electrolyte membrane 22, the anode 23, the cathode 24, the gas diffusion layers 25 and 26, and the separators 27 and 28) and internal resistances of the respective constituents, especially a membrane resistance of the electrolyte membrane 22 and internal resistances of the separators 27 and 28. Among these resistances, the membrane resistance significantly varies according to the operating conditions of the fuel cells 20 (for example, the gas flow rates, the amount of humidification, the gas pressures, and the temperature). The magnitude of the resistance in the unit cell during power generation of the fuel cells 20 suggests the moisture state of the electrolyte membrane 22 and thereby the moisture state of the unit cell. In general, the sufficiently wet state of the electrolyte membrane 22 decreases the membrane resistance and the overall resistance in the unit cell. The relatively dry state of the electrolyte membrane 22, on the other hand, increases the membrane resistance and the overall resistance in the unit cell. The comparison between the average resistance value R(n) after noise elimination by the averaging process and the preset reference value A at step S130 identifies whether the specific unit cell has the moistening tendency based on the present general tendency of the resistance value.

When the average resistance value R(n) is smaller than the preset reference value A at step S130, it is identified that the specific unit cell has the moistening tendency. The CPU 55 subsequently calculates a standard deviation of the average resistance value R(n) (step S140). The standard deviation is calculated from a preset number of average resistance values (for example, ‘j’ average resistance values) obtained retrospectively from the latest average resistance value R(n). Namely the CPU 55 calculates the standard deviation of average resistance values R(n−j+1) to R(n). The processing of step S140 successively shifts the range of the average resistance value as the object of calculation of the standard deviation by one to include the latest average resistance value at every execution of step S140. In the description hereafter, σR(n) denotes the standard deviation of the average resistance value calculated at step S140 in the n-th cycle of this routine after activation. The sampling number ‘j’ of the average resistance values used for calculation of the standard deviation may be set arbitrarily, as long as the standard deviation of the average resistance value calculated at step S140 represents the degree of a variation in average resistance value at the moment.

The CPU 55 subsequently compares the standard deviation σR(n) calculated at step S140 with a preset reference value B (step S150). The reference value B used for the comparison at step S150 is set in advance as a value of identifying unstable power generation state of the unit cell and is stored in the controller 54. When the standard deviation σR(n) is not smaller than the preset reference value B, it is determined that the unit cell is in the unstable power generation state. The reference value B may be set arbitrarily according to the sampling number ‘j’ of the average resistance values, the sampling number ‘i’ of the resistance values used for the averaging process, and the time interval of acquisition of the voltage value at step S100.

When the standard deviation σR(n) is smaller than the preset reference value B at step S150, the CPU 55 sets a flooding countermeasure execution flag to 0 (step S160) and terminates this routine. When the standard deviation σR(n) is not smaller than the preset reference value B at step S150, on the other hand, the CPU 55 sets the flooding countermeasure execution flag to 1 (step S170) and terminates this routine. As explained previously, at the sufficiently small resistance value of the fuel cells 20 (when the average resistance value R(n) is smaller than the preset reference value A at step S130 in the flowchart of FIG. 4), the electrolyte membrane 22 is identified to be in the sufficiently wet state. In the sufficiently wet state of the electrolyte membrane 22 with the sufficiently small standard deviation of the average resistance value suggesting the stable power generation state of the fuel cells 20, the fuel cells 20 are detected to be in the desired state of assuring smooth gas flows and having little potential for flooding. In the sufficiently wet state of the electrolyte membrane 22 with the relatively large standard deviation of the average resistance value suggesting the unstable power generation state of the fuel cells 20, on the other hand, the fuel cells 20 are detected to be in the overhydration state having the high potential for flooding. Namely the controller 54 functions as the overhydration detection module of the invention to detect the overhydration state of the fuel cells when the standard deviation of the average resistance value exceeds the preset reference value after identification of the moistening tendency of the fuel cells.

As described above, the controller 54 controls the operations of the respective constituents in the fuel cell system 10. In power generation of the fuel cells 20, the controller 54 receives a loading demand of the load 64 and controls the conditions related to the fuel gas and the oxidizing gas supplied to the fuel cells 20, for example, the gas flow rates and the gas pressures, to enable generation of electric power corresponding to the loading demand. In response to setting of the flooding countermeasure execution flag to ‘1’ at step S170 during power generation of the fuel cells 20, the controller 54 changes the control conditions from the standard conditions based on the loading demand to the conditions for preventing the flooding. When the water vapor pressure of the gas does not reach the saturated vapor pressure, the increase in total amount of the gas prevents the occurrence of flooding. With regard to the oxidizing gas, the controller 54 accordingly controls the blower 42 to increase the flow rate of the oxidizing gas and the oxidizing gas pressure from the standard conditions based on the loading demand. With regard to the fuel gas, the controller 54 controls the pressure regulator 33 to increase the flow rate of the fuel gas and the fuel gas pressure from the standard conditions based on the loading demand.

In the fuel gas conduit 34 and/or the oxidizing gas conduit 44 equipped with a humidifier for humidifying the gas, in response to the setting of the flooding countermeasure execution flag to ‘1’, the amount of humidification by the humidifier may be decreased from the standard condition. Another modified control operation may increase the internal temperature of the fuel cells 20 in response to the setting of the flooding countermeasure execution flag to ‘1’. In the structure of the cooling medium flow path for passage of the cooling medium flows through a radiator equipped with a cooling fan inside the fuel cells 20, the operation of the cooling fan may be stopped to raise the internal temperature of the fuel cells 20. Still another modified control operation may change the setting of the load 64 to decrease the load 64 than the input loading demand (when the load 64 is a motor, the setting value of the driving amount is decreased). This reduces the amount of power generation and decreases the amount of water produced, thus preventing the progress of flooding. At the setting of the flooding countermeasure execution flag to ‘0’, the control procedure does not require any of such specific control operations but sets the standard condition based on the loading demand.

When the average resistance value R(n) is not smaller than the preset reference value A at step S130, it is determined that the electrolyte membrane 22 is in the relatively dry state and has little potential for flooding. In this case, the CPU 55 sets the flooding countermeasure execution flag to ‘0’ at step S160 and terminates the flooding detection routine.

In the fuel cell system 10 of the embodiment described above, under the conditions of the low cell resistance (the average resistance value of smaller than the preset reference value A), the sufficiently wet state of the electrolyte membrane 22, and a large variation of the average resistance value, the fuel cells 20 are detected to be in the overhydration state having the high potential for flooding. This arrangement allows the quick detection of flooding to take an adequate countermeasure to prevent the progress of the flooding.

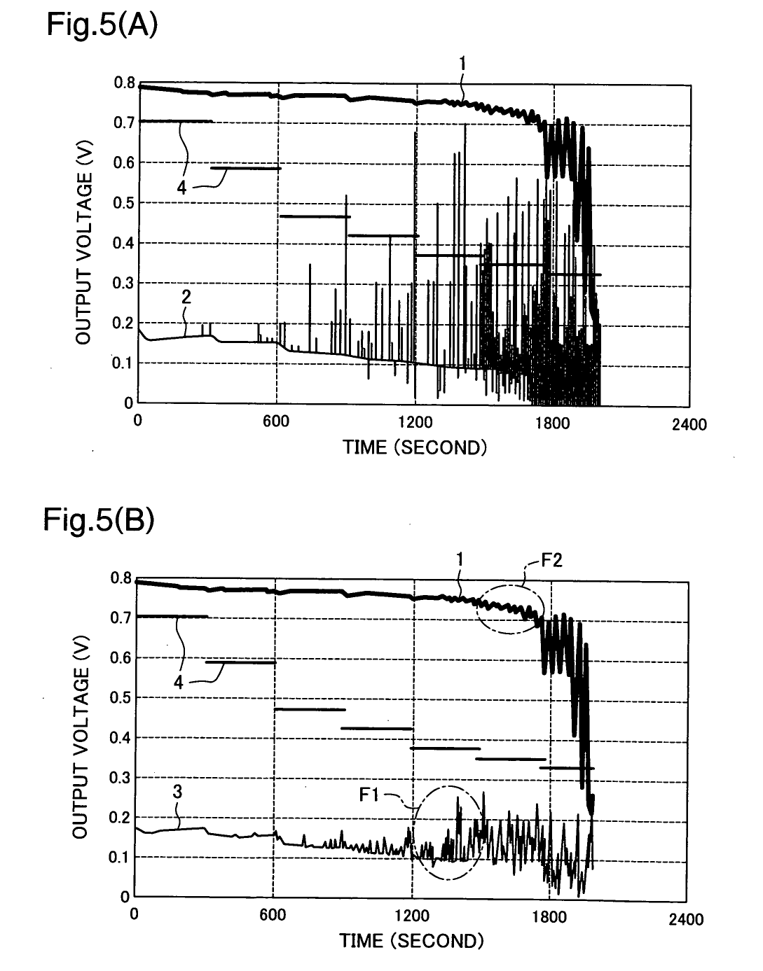

FIG. 5 shows variations of observed voltage and computed resistance value with a gradual change of the internal state of the fuel cells 20 to a flooding prone state by changing the gas supply conditions to the fuel cells 20 in the fuel cell system 10 of the embodiment. The conditions of the experiments are that the fuel cells 20 are connected to the load 64 of a constant magnitude, a fixed amount of the fuel gas sufficient for the magnitude of the load 64 is supplied to the anodes, the flow rate of the oxidizing gas supplied to the cathodes is gradually decreased at preset time intervals, and the water vapor pressure of the oxidizing gas is lower than the saturated vapor pressure.

In FIGS. 5(A) and 5(B), a plot 1 represents a time change of the output voltage in the specific unit cell of the fuel cells 20 (the output voltage measured by the voltage sensor 70). The voltage measured by the voltage sensor 70 is the sum of the direct current output voltage produced by power generation of the fuel cells 20 and the alternating current voltage attributed to application of the alternating current by the alternating current generator 52. The applied alternating current is extremely weaker than the output voltage responding to the load 64. The plot 1 thus approximately represents a time change of the output voltage responding to the load 64. The plot 1 in FIGS. 5(A) and 5(B) shows the time change of the output voltage detected at every one second.

A plot 2 in FIG. 5(A) shows a time change of the resistance value in the specific unit cell calculated at step S110 from the voltage value of the alternating current component obtained at step S100 in the flowchart of FIG. 4. The voltage value of the alternating current component is obtained at every one second at step S100, so that the plot 2 shows a time change of the resistance value at every one second calculated from the voltage value obtained at every one second. A plot 3 in FIG. 5(B) shows a time change of the average resistance value R(n) computed at step S120 in the flowchart of FIG. 4. The sampling number ‘i’ of the resistance values for computation of the average resistance value R(n) is 16. In FIGS. 5(A) and 5(B), a plot 4 shows a time change of decreasing the flow rate of the oxidizing gas supplied to the fuel cells 20.

A gradual decrease in flow rate of the oxidizing gas having the water vapor pressure of lower than the saturated vapor pressure decreases the amount of water vaporized to enter the oxidizing gas and thus gradually increases the water content in the electrolyte membrane 22. The increase in water content of the electrolyte membrane 22 gradually decreases the average resistance value R as shown by the plot 3 in FIG. 5(B). A further increase in water content of the electrolyte membrane 22 makes the electrolyte membrane 22 in the overhydration state having a high potential for flooding inside the fuel cells 20 and causes a greater variation in average resistance value R. It is determinable whether the electrolyte membrane 22 is in the overhydration state having a high potential for flooding by adequately setting the sampling number ‘j’ of the average resistance values R as the calculation object of the standard deviation at step S140 and the reference value B used for the comparison at step S150 in the flowchart of FIG. 4. The sampling number ‘j’ of the average resistance values R as the calculation object of the standard deviation is 60. At the average resistance value R in an area F1 of FIG. 5(B), it is determined that the electrolyte membrane 22 is in the overhydration state having a high potential for flooding.

In the overhydration state of the electrolyte membrane 22, the output voltage of the unit cell gradually has a greater variation. With a certain progress of the flooding, the voltage value is significantly lowered (see the plot 1). The flooding may thus be detected in response to such an increased variation of the output voltage. A significant increase of the variation in output voltage is, however, observable later than a significant increase of the variation of the average resistance value R. As shown in FIG. 5(B), the overhydration state is detectable based on the increased variation of the average resistance value R at a timing corresponding to the area F1, while being detectable based on the increased variation of the output voltage at a later timing corresponding to an area F2.

The procedure of monitoring the moisture state inside the fuel cells based on the variation of the average resistance value with regard to the alternating current component attributed to application of the high-frequency alternating current, enables the quicker detection of the overhydration state, compared with the procedure of monitoring the moisture state based on the variation of the output voltage to the load. This is because the excess water content inside the fuel cells causes a voltage change in a limited small area on the electrolyte membrane 22 even before the progress of flooding to an extent of causing a significant drop or a significant variation of the output voltage. Liquid water produced in the limited small area on the electrolyte membrane 22 partially worsens the gas flow and interferes with smooth power generation. The partial interference of the produced liquid water with power generation makes the flow of electric current bypass a power generation interference site on the catalyst-containing electrode plane to give an IR loss, while worsening the power generation efficiency by the concentration of electric current in an unaffected area. This leads to the voltage change in the limited small area on the electrolyte membrane 22. It is difficult to separate such a voltage change caused by the local flow of electric current on the electrode surface from the overall output voltage to the load. The procedure of the embodiment applies the weak high-frequency alternating current to the fuel cells 20 and extracts only an alternating current component of the voltage to enable separation of the voltage change in the limited small area. This arrangement enables the quicker detection of the overhydration state before the progress of flooding to the extent of causing a significant drop or a significant variation of the output voltage of the fuel cells to the load without being affected by a change in overall power generation of the fuel cells.

C. Other Aspects

The embodiment discussed above is to be considered in all aspects as illustrative and not restrictive. There may be many modifications, changes, and alterations without departing from the scope or spirit of the main characteristics of the present invention. Some examples of possible modification are given below.

(1) The flooding detection procedure of the embodiment performs the averaging process (step S120) of the calculated cell resistance value (step S110), prior to the identification of the moistening tendency of the unit cell based on the calculated cell resistance value (step S230) and the detection of the potential for flooding (step S150). The averaging process is not restricted to the calculation of the simple arithmetic average as in the procedure of the embodiment, but any other operation may be performed to eliminate the noise included in the cell resistance value calculated from the observed voltage value. For example, the calculation of the simple arithmetic average may be replaced by calculation of a weighted average with addition of a weight to the latest cell resistance value.

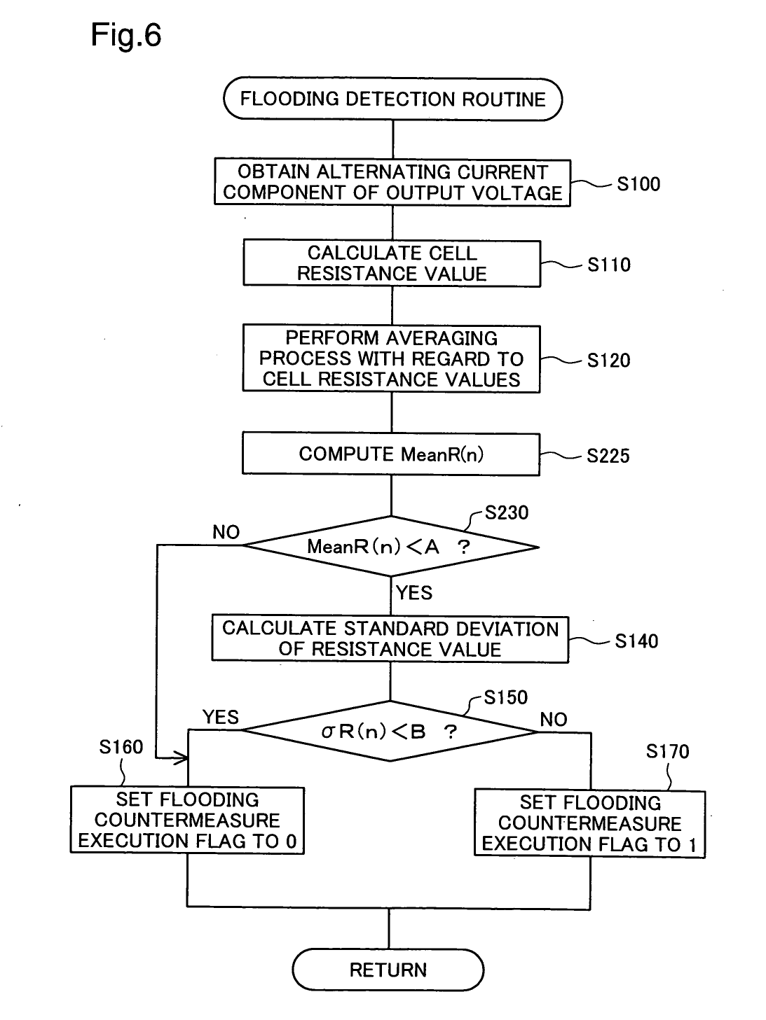

(2) The flooding detection procedure of the embodiment compares the average resistance value R with the preset reference value A at step S130 to identify whether the unit cell has the moistening tendency having the high potential for flooding. The object of comparison is, however, not limited to the average resistance value R but may be any other suitable factor indicating a low level of the resistance value in the unit cell with the electrolyte membrane 22 in the sufficiently wet state. FIG. 6 shows one modified flow of the flooding detection routine. The like steps in this modified flow of FIG. 6 to those in the flooding detection routine of FIG. 4 are expressed by the like step numbers and are not explained here. The modified flow of FIG. 6 executes the processing of steps S225 and S230, instead of the processing of step S130 in the flowchart of FIG. 4. The CPU 55 calculates a block mean MeanR(n) of the average resistance value R at step S225. The block mean MeanR(n) represents a mean value of a preset number of average resistance values R (for example, ‘j’ average resistance values) obtained retrospectively from the latest average resistance value R(n) and is expressed by Equation (1) given below:

MeanR(n)=R(n)+R(n−1)+ . . . +R(n−j+1)/j (1)

The processing of step S225 successively shifts the range of the average resistance value as the object of calculation of the block mean MeanR(n) of the average resistance value by one to include the latest average resistance value at every execution of step S225. As long as the block mean MeanR(n) calculated at step S225 can represent the level of the average resistance value at the moment, the sampling number ‘j’ of the average resistance values for calculation of the block mean may be set arbitrarily. The CPU 55 then compares the block mean MeanR(n) with the preset reference value A and identifies whether the unit cells has the moistening tendency (step S230) in the same manner as step S130 in the flowchart of FIG. 4. The block mean MeanR(n) of the averaged cell resistance values is usable as the indicator of the level of the resistance value to identify the moistening tendency of the unit cell.

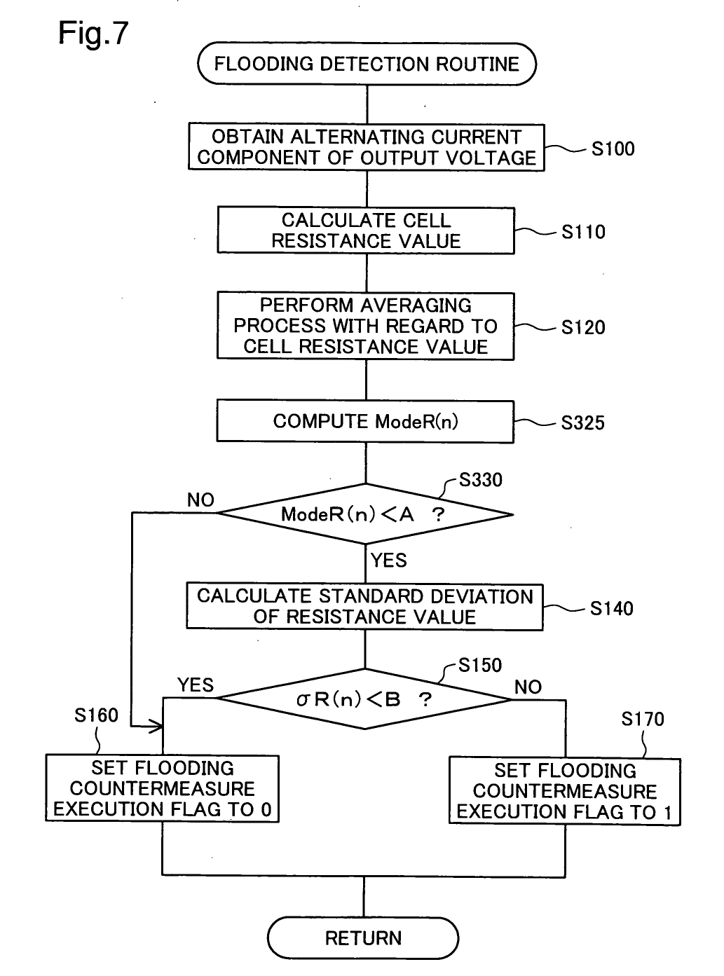

FIG. 7 is a flowchart showing another modified flow of the flooding detection routine. The like steps in this modified flow of FIG. 7 to those in the flooding detection routine of FIG. 4 are expressed by the like step numbers and are not explained here. The modified flow of FIG. 7 executes the processing of steps S325 and S330, instead of the processing of step S130 in the flowchart of FIG. 4. The CPU 55 specifies a block mode value ModeR(n) of the average resistance value R at step S325. The block mode value ModeR(n) represents a most-frequently appearing value in a frequency distribution of a preset number of average resistance values R obtained retrospectively from the latest average resistance value R(n).

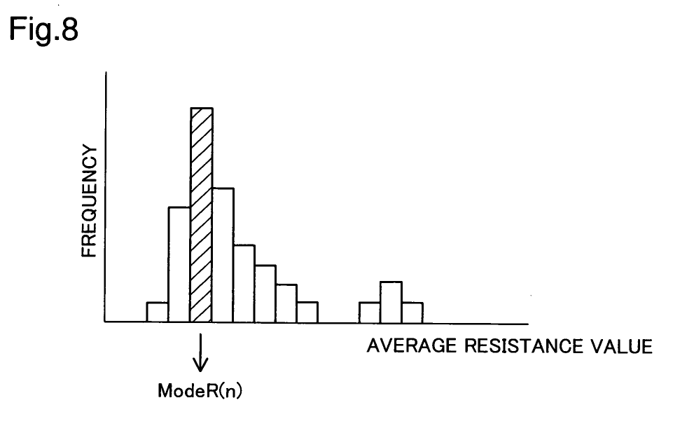

FIG. 8 shows a frequency distribution of a preset number of average resistance values R obtained retrospectively from the latest average resistance value R(n). The procedure divides a numerical coverage of the average resistance value R into plural numeric zones, and classifies the preset number of average resistance values into these numeric zones. The procedure then counts the number (frequency) of the average resistance values belonging to each numeric zone and specifies the median of the numeric zone with the highest frequency as the block mode value ModeR(n).

The processing of step S325 successively shifts the range of the average resistance value as the object of specification of the block mode value ModeR(n) of the average resistance value by one to include the latest average resistance value at every execution of step S325. As long as the block mode value ModeR(n) specified at step S325 can represent the level of the average resistance value at the moment, the sampling number of the average resistance values for specification of the block mode value may be set arbitrarily. The CPU 55 then compares the block mode value ModeR(n) with the preset reference value A and identifies whether the unit cells has the moistening tendency (step S330) in the same manner as step S130 in the flowchart of FIG. 4. The block mode value ModeR(n) of the averaged, cell resistance values is usable as the indicator of the level of the resistance value to identify the moistening tendency of the unit cell.

The flooding detection procedure of the embodiment uses the averaged cell resistance value to identify whether the unit cell has the moistening tendency having the high potential for flooding at step S130. The identification of the moistening tendency is, however, not restricted to this procedure. One possible modification may use a temperature sensor attached to the fuel cells 20 and identify the moistening tendency of the fuel cells 20 when the internal temperature of the fuel cells 20 is lower than a preset reference temperature. Another possible modification may identify the moistening tendency of the fuel cells 20 when the flow rate of the fuel gas and/or the oxidizing gas supplied to the fuel cells 20 is not higher than a preset reference level. Still another possible modification may detect an insufficient temperature increase in the fuel cells 20 and identify the moistening tendency of the fuel cells 20 when a time elapsed since activation of the fuel cell system 10 does not exceed a preset reference time.

(3) The flooding detection procedure of the embodiment determines whether the unit cell is in the overhydration state having the high potential for flooding, based on the standard deviation of the average resistance value R(n) at step S150. The use of the standard deviation is, however, not essential. The standard deviation may be replaced by any statistical value representing a variation of the averaged resistance value, for example, a variance.

(4) On the basis that the moisture state of the electrolyte membrane 22 affects the resistance value of the unit cell, the flooding detection procedure of the embodiment utilizes the resistance value calculated from the observed voltage value of the alternating current component to identify the moistening tendency of the unit cell and to detect the overhydration state of the unit cell. The resistance value is calculated by dividing the observed voltage value of the alternating current component by the constant value of applied electric current. One possible modification may thus perform the identification of the moistening tendency and the detection of the overhydration state based on the observed voltage value of the alternating current component without calculation of the resistance value. In the modified flow of the flooding detection routine of FIG. 4 skips the processing of step S110 and performs the averaging process based on the observed voltage value of the alternating current component at step S120. At subsequent step S130, the averaged voltage value is compared with a preset reference value. The moistening tendency of the unit cell is identified when the averaged voltage value is smaller than the reference value. The modified flow calculates a standard deviation of the averaged voltage value at step S140 and compares the standard deviation with a preset reference value at step S150. The overhydration state of the unit cell is detected when the standard deviation is not smaller than the reference value. This modification directly uses the observed voltage value without calculating the resistance value, thus reducing the processing load for the identification of the moistening tendency and the detection of the overhydration state.

(5) In the fuel cell system 10 of the embodiment, the voltage detection assembly 50 is provided for one single unit cell. The voltage detection assembly 50 may be provided for each of multiple unit cells selected in the stack structure of the fuel cells 20. In this modified structure, a constant alternating current is applied to the fuel cells 20, and the overhydration state is detected in each of the multiple unit cells equipped with the voltage detection assemblies 50 based on the extracted alternating current component of the observed voltage. The flooding detection routine described above is executed for each of the selected multiple unit cells and takes the adequate countermeasure against the flooding in response to detection of the overhydration state in any of these unit cells.

1. A fuel cell system equipped with polymer electrolyte fuel cells, the fuel cell system comprising:
an alternating current component generator configured to apply an alternating current of a fixed frequency and a fixed amplitude to the fuel cells;
an alternating current voltage acquisition module configured to extract an alternating current voltage component attributed to the application of the alternating current from an output voltage in a specific unit cell of the fuel cells and to time-sequentially obtain a voltage value of the extracted alternating current component; and
an over-hydration detection module configured to determine whether the fuel cells are in an over-hydration state, the over-hydration detection module computing a statistical value representing a magnitude of a variation in time-sequentially obtained voltage value of the alternating current component by the alternating current voltage acquisition module, and determining that the fuel cells are in an over-hydration state when the computed statistical value representing the magnitude of the variation exceeds a preset reference level.

2. The fuel cell system in accordance with claim 14, wherein the moisture state monitoring module performs an averaging process with regard to a value correlated to the time-sequentially obtained voltage value of the alternating current component to compute an averaged value and identifies that the fuel cells have the moistening tendency when the averaged value is smaller than a preset reference value.

3. The fuel cell system in accordance with claim 14, wherein the moisture state monitoring module performs an averaging process with regard to a value correlated to the time-sequentially obtained voltage value of the alternating current component to successively compute averaged values, specifies an averaged value of a highest frequency as a mode averaged value among the successively computed averaged values, and identifies that the fuel cells have the moistening tendency when the mode averaged value is smaller than a preset reference value.

4. The fuel cell system in accordance with claim 2, wherein the moisture state monitoring module successively calculates a resistance value in the specific unit cell from the time-sequentially obtained voltage value of the alternating current component and a value of the applied alternating current and performs the averaging process with regard to the resistance value, as the value correlated to the time-sequentially obtained voltage value, to compute the averaged value.

5. The fuel cell system in accordance with claim 14, the fuel cell system further comprising:
a temperature sensor configured to measure an internal temperature of the fuel cells,
wherein the moisture state monitoring module identifies that the fuel cells have the moistening tendency when the internal temperature of the fuel cells measured by the temperature sensor is lower than a preset reference temperature.

6. The fuel cell system in accordance with claim 14, wherein the moisture state monitoring module identifies that the fuel cells have the moistening tendency when a flow rate of a gas supplied to the fuel cells does not exceed a preset reference level.

7. (canceled)

8. The fuel cell system in accordance with claim 14, wherein the over-hydration detection module successively calculates a resistance value in the specific unit cell from the time-sequentially obtained voltage value of the alternating current component and a value of the applied alternating current and computes a statistical value representing a magnitude of a variation in resistance value as the statistical value representing the magnitude of the variation in time-sequentially obtained voltage value.

9. The fuel cell system in accordance with claim 14, the fuel cell system further comprising:
a flooding countermeasure execution module that takes a flooding countermeasure to avoid flooding, in response to determination that the fuel cells are in the over-hydration state.

10. The fuel cell system in accordance with claim 9, wherein the flooding countermeasure increases an oxidizing gas flow rate and an oxidizing gas pressure, which are determined according to a loading demand of a load as a target of supply of electric power from the fuel cell system, to avoid the flooding.

11. The fuel cell system in accordance with claim 9, wherein the flooding countermeasure increases a fuel gas flow rate and a fuel gas pressure, which are determined according to a loading demand of a load as a target of supply of electric power from the fuel cell system, to avoid the flooding.

12. An over-hydration detection method in a fuel cell system equipped with polymer electrolyte fuel cells, the over-hydration detection method comprising:
applying an alternating current of a fixed frequency and a fixed amplitude to the fuel cells;
extracting an alternating current voltage component attributed to the application of the alternating current from an output voltage in a specific unit cell of the fuel cells and time-sequentially obtaining a voltage value of the extracted alternating current voltage component; and
computing a statistical value representing a magnitude of a variation in time-sequentially obtained voltage value of the alternating current voltage component and determining that the fuel cells are in an over-hydration state when the computed statistical value representing the magnitude of the variation exceeds a preset reference level.

13. The over-hydration detection method in accordance with claim 12, the over-hydration detection method further comprising:
Identifying whether the fuel cells have a moistening tendency
in the case of identification of the moistening tendency of the fuel cells, the over-hydration detection method determining whether the fuel cells are in the over-hydration state.

14. The fuel cell system in accordance with claim 1, the fuel cell system further comprising:
a moisture state monitoring module configured to identify whether the fuel cells have a moistening tendency,
wherein in the case of identification of the moistening tendency of the fuel cells by the moisture state monitoring module, the over-hydration detection module determines whether the fuel cells are in the over-hydration state.

15. The fuel cell system in accordance with claim 3, wherein the moisture state monitoring module successively calculates a resistance value in the specific unit cell from the time-sequentially obtained voltage value of the alternating current component and a value of the applied alternating current and performs the averaging process with regard to the resistance value, as the value correlated to the time-sequentially obtained voltage value, to compute the averaged value.
